(19) United States
(12) Patent Application Publication
(10) Pub. No.: US 2008/0108024 A1
(43) Pub. Date: May 8, 2008

(54) USE OF HEARING DEVICES FOR DISTRIBUTING DATA, AND CORRESPONDING METHODS AND DEVICES

(75) Inventor: Bernd Waldmann, Maur (CH)

Correspondence Address: PEARNE & GORDON LLP, 1801 EAST 9TH STREET, SUITE 1200, CLEVELAND, OH, 44114-3108, US

(73) Assignee: PHONAK AG, Staefa (CH)

(21) Appl. No.: 11/551,751

(22) Filed: Oct. 23, 2006

(51) Int. Cl. G09B 21/00

(52) U.S. Cl. 434/112

(57) ABSTRACT

The method for supplying a recipient with materials comprises the steps of
a) providing said materials in form of digital data;
b) providing a device of a hearing system, which device comprises a non-volatile memory;
c) storing said digital data in said memory;
d) forwarding said device to said recipient;
e) reading said digital data from said memory.

The device of a hearing system comprises
a non-volatile memory;
materials to be supplied to a recipient, stored in said memory in form of digital data.

A use of a device of a hearing system for supplying a recipient with materials stored in a non-volatile memory of said device is disclosed. Preferably, said materials are hearing-related materials such as sales promotion materials, materials providing scientific information, training materials, educational materials. Preferably, said memory is free from data, which are individual to a user of said hearing system.

### TECHNICAL FIELD

The invention has its origin in the field of hearing devices. Nevertheless, it relates to a method for supplying a recipient with materials, such as aural rehabilitation materials, sales promotion materials and other information materials. It furthermore relates to a device of a hearing system and to a use of a device of a hearing system.

A hearing system comprises at least one hearing device. Typically, a hearing system comprises, in addition, at least one additional device, which is operationally connected to said hearing device, e.g., another hearing device, a remote control or a remote microphone.

Under a hearing device, a device is understood, which is worn in or adjacent to an individual's ear with the object to improve the individual's acoustical perception. Such improvement may also be barring acoustic signals from being perceived in the sense of hearing protection for the individual. If the hearing device is tailored so as to improve the perception of a hearing impaired individual towards hearing perception of a “standard” individual, then we speak of a hearing-aid device. With respect to the application area, a hearing device may be applied behind the ear, in the ear, completely in the ear canal or may be implanted.

### BACKGROUND OF THE INVENTION

A hearing device manufacturer supplies his clients, typically hearing device dispensers like audiologists, with various kinds of materials. For example, brochures about new products and other printed materials are mailed to the client, as are CD-ROMS containing aural rehabilitation materials (also referred to as auditory rehabilitation materials) such as audio and/or video media files. Various types of information are also made available to the client via the internet.

The production of printed materials and/or CD-ROMS generates considerable costs, and so does the mailing of materials to the client. In addition, said production of printed materials and/or CD-ROMS requires a considerable amount of time. The logistic efforts can be overcome by using the internet as a distribution channel, but not every client has access to the internet.

It is desirable to provide for an alternative way of supplying a recipient with materials.

In EP 1 473 969 A2, a hearing instrument is described, which itself comprises a fitting software.

### SUMMARY OF THE INVENTION

Therefore, one object of the invention is to create a method for supplying a recipient with materials, that does not have the disadvantages mentioned above. A device of a hearing system shall be provided, which can be used in this method. In addition, a corresponding hearing system and the respective use of a device of a hearing system shall be provided.

Another object of the invention is to provide for a cost-efficient way of distributing materials.

Another object of the invention is to provide for a time-saving way of distributing materials.

Further objects emerge from the description and embodiments below.

At least one of these objects is at least partially achieved by apparatuses and methods according to the patent claims.

According to the invention, the method for supplying a recipient with materials comprises the steps of
a) providing at least a part of said materials in form of digital data;
b) providing a device of a hearing system, which device comprises a non-volatile memory;
c) storing said digital data in said memory;
d) forwarding said device to said recipient.

According to the invention, the device of a hearing system comprises
a non-volatile memory;
digital data stored in said memory, which represent at least a part of materials to be supplied to a recipient.

The hearing system according to the invention comprises a device according to the invention.

The use according to the invention is a use of a device of a hearing system for supplying a recipient with materials, wherein at least a part of said materials is stored in a non-volatile memory of said device.

Through this, a new way for the distribution of materials is established.

It has been found, that usually, a shipping of (usually new) hearing devices or other devices of hearing systems to a hearing device dispenser occurs rather frequently, and that this anyway-existing distribution channel could be used for supplying a recipient with various other materials.

In one embodiment, the method comprises the step of
e) reading said digital data from said memory.

Step e) is preferably carried out after step d).

In one embodiment, said materials are hearing-related materials. A major part of materials to be forwarded from a hearing device manufacturer to a hearing device dispenser relates to hearing. This comprises information about hearing devices or hearing systems or hearing-related events, scientific information concerning the hearing, software specifically for hearing device users and/or individuals dealing with hearing device users.

In one embodiment, said materials are free from materials to be used for operating or adjusting said device of said hearing system, or said materials comprise materials in addition to materials to be used for operating or adjusting said device of said hearing system. This confines said materials to materials of which it is not expected that they would be comprised in said device.

In a similar embodiment, said materials are free from materials to be used for operating or adjusting a hearing device, or said materials comprise materials in addition to materials to be used for operating or adjusting a device of said hearing system. This, too, confines said materials to materials of which it is not expected that they would be comprised in said device.

In one embodiment, said memory is rewritable. This allows to store other data in said memory after having used said memory for storing the above-described materials, and in particular after step e) has been carried out.

In one embodiment, said materials comprise at least one of the group comprising
sales promotion materials, in particular materials describing best practices in the field of hearing health care and/or materials related to new products;
materials providing scientific information;
materials providing hearing-related news, in particular materials announcing upcoming events;
training materials, in particular aural rehabilitation materials;
educational materials, in particular simulation and/or demonstration materials.

Said materials may comprise, e.g., brochures, flyers, publications, fair announcements, software for users of hearing systems and/or for individuals related to a user of hearing system.

In one embodiment, said method comprises after step e) the step of
f) deleting said digital data from said memory, in particular wherein deleting comprises overwriting with different data.

This way, said memory can be used for different data after having been used for said digital data representing said materials. And space—and therefore also memory—is scarce, in particular in hearing devices.

In one embodiment, said memory is adapted to comprise—during normal operation of said hearing system—data, which are individual to a user of said hearing system.

In particular, said data individual to said user comprise data, which are obtained by adjusting said hearing system to individual preferences of said user of said hearing system and/or data describing the hearing of said user of said hearing system.

In most of today's hearing systems, there is memory comprised for storing, e.g., parameters for controlling the function of the hearing system and/or audiogram data of said user. Such memory can be used for temporarily storing said digital data representing at least a part of said materials.

In one embodiment, during step d), said memory is free from data, which are individual to a user of said hearing system. More particularly, said device is free from data, which are individual to a user of said hearing system.

In one embodiment, said device is not adapted to individual preferences of a user. E.g., a new, non-individualized device of a hearing system is used for transferring above-described materials to said recipient, and after that, said device can be individualized in dependence of preferences of an individual, said user.

In one embodiment, said device is a hearing device.

In one embodiment, said recipient is a hearing device dispenser.

In one embodiment, said materials are to be used by said recipient and/or by persons related to said recipient, in particular clients of said recipient and/or persons related to said clients.

In one embodiment, a fitting software suitable to adapting said device to the individual preferences of a user of said device is used for carrying out step e).

Such fitting software is typically already capable of accessing memory in devices of hearing systems, so that only minor adjustments would have to be made to an existing fitting software for handling said digital data representing said materials.

In case that the digital data stored in the memory of the device of the hearing system represent only a part of the materials with which the recipient shall be supplied, said digital data will typically be stored and be put together with further data for generating a data set, which represents said materials in full.

The advantages of the apparatuses and uses correspond to the advantages of corresponding methods.

Further preferred embodiments and advantages emerge from the dependent claims and the figures.

### BRIEF DESCRIPTION OF THE DRAWINGS

Below, the invention is described in more detail by means of examples and the included drawings. The figures show schematically:

FIG. 1 a hearing system according to the invention;

FIG. 2 an illustration of a method according to the invention.

The reference symbols used in the figures and their meaning are summarized in the list of reference symbols. Generally, alike or alike-functioning parts are given the same or similar reference symbols. The described embodiments are meant as examples and shall not confine the invention.

### DETAILED DESCRIPTION OF THE INVENTION

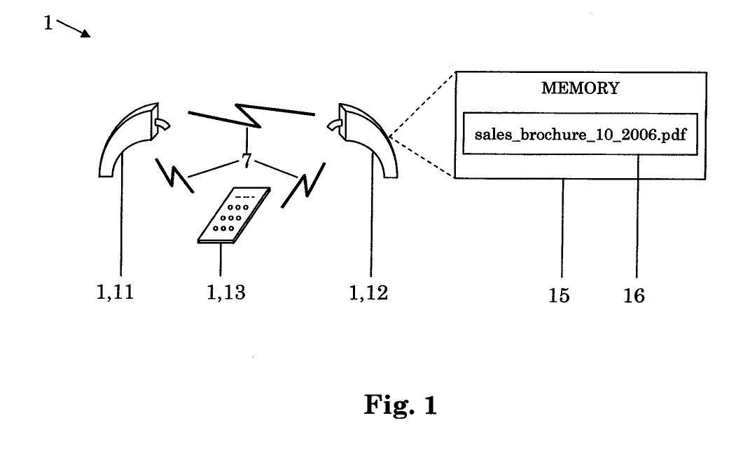

FIG. 1 schematically shows a hearing system 1 according to the invention. The hearing system 1 comprises three devices: two hearing device 11,12 and a remote control 13. The devices 11,12,13 are operationally interconnected, e.g, by means of wireless short-range communication links 7. Hearing device 12 comprises a non-volatile rewritable memory 15, in which digital data 16 are stored, which represent marketing material, e.g., a pdf-file representing a sales brochure.

Said memory 16 comprises, during normal operation of said hearing system 1, data which individualize said device 12 or said hearing system 1 with respect to its user, i.e., with respect to the person wearing said hearing system 1.

Said digital data 16 do not represent data that could be used for operating or adjusting the device 12 or the hearing system 1.

The digital data 16 are only temporarily stored in device 12. After reading digital data 16 from memory 15, they can be deleted, e.g., by overwriting them with other data, in particular with data that are individual to a user of the hearing system 1.

Digital data 16 can, e.g., be stored and/or displayed and/or printed and/or executed and/or forwarded to an envisaged recipient.

If digital data 16 represent only a part of the materials with which a recipient shall be supplied, digital data 16 will typically be stored and be put together with further data for generating a data set, which represents said materials in full. Said further data can preferably be transported in the same way as digital data 16 have been, but usually, a different device of a hearing system will be used. Said data set can be subjected to further processing as it has been depicted above for digital data 16, e.g., it can be stored and/or displayed and/or printed and/or executed and/or forwarded to an envisaged recipient.

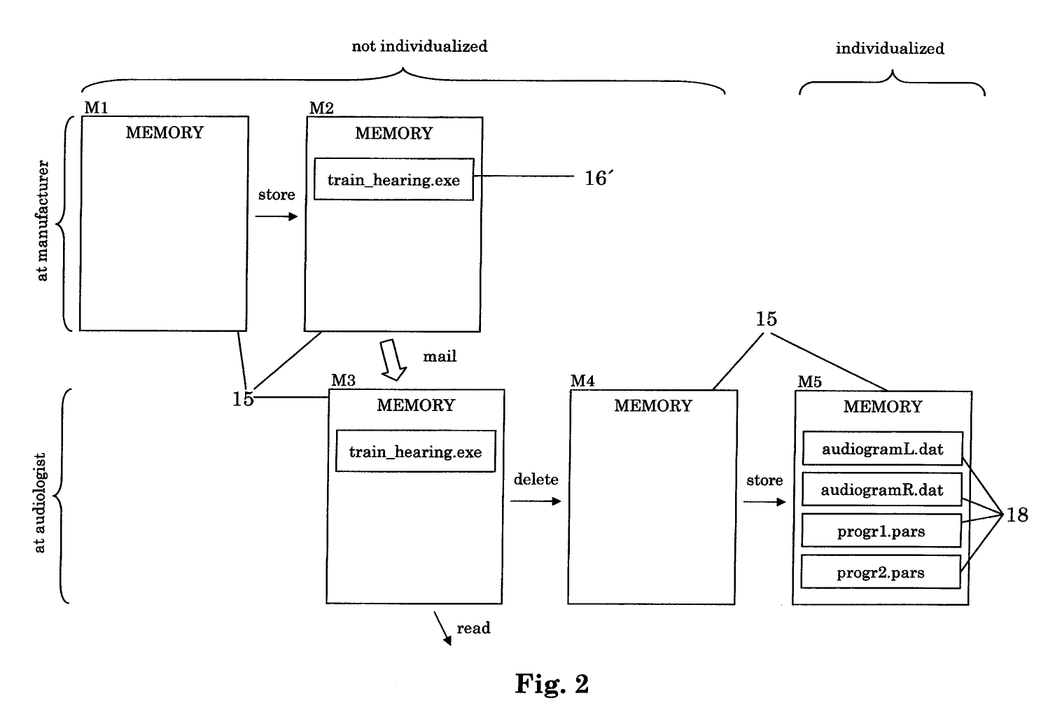

Further details of the invention will become clear from the description of FIG. 2.

FIG. 2 is a schematic illustration of a method according to the invention. From left to right in FIG. 2, there runs approximately a time axis, while the upper half of FIG. 2 illustrates the memory 15 of a device of a hearing system when the device is at the device manufacturer's place and the lower half of FIG. 2 illustrates the memory 15 of said device when the device is at an audiologist's place.

The different states of memory 15 are labelled M1 . . . M5.

After its manufacture, cf. M1, the—new—device is not yet individualized with respect to a user. At least memory 15 is free from data that would be individual to a user of the device.

Then, digital data 16′ are stored in memory 15 (cf. M2). These data 16′ are not individual to a user of the device. Data 16′ comprises data representing, e.g., a hearing training application software for a hearing-impaired person, and/or sales promotion material for a hearing device dispenser, and/or scientific papers on hearing, or announcements of fairs and/or demonstration material such as application programs demonstrating the hearing of a hearing-impaired person.

In case that data 16′ comprise aural rehabilitation material, these typically comprise audio and/or video media files and/or computer-assisted training programs. Examples of aural rehabilitation materials can be found, e.g., in US 2005/0287501 A1.

It is possible, that memory 15 comprises in states M2,M3 default data for parameters of the hearing system.

Of course, the data 16′ can be stored in a compressed form in memory 15. This saves storage space.

Then, the device is (physically) forwarded to a recipient, e.g., by mail to a hearing device dispenser such as said audiologist. Since memory 15 is non-volatile, its contents remains unchanged (cf. M3).

Then, said digital data 16′ are read from memory 15. Data 16′ will usually be displayed on a display, e.g., a computer monitor, and/or will be printed out. Typically, data 16′ are stored in another storage means, such as a computer memory, a hard disk, a memory stick, a suitable CD or DVD.

If application programs are comprised in data 16′, these can be executed immediately or later.

In any event, the data 16′ are usually not related to a user of the device. It can, during states M1 to M4, even be still unclear who will later on be the user of the device.

Preferably, said reading-out of data 16′ can be accomplished by means of a fitting software. A hearing device dispenser usually has a fitting software installed on a suitable computer system, which is capable of reading data from the memory of hearing devices. In addition to its primary object of adjusting hearing devices to the preferences of a user, the fitting software has to be able to correctly extract data 16′ from memory 15.

After data 16′ have been read out from memory 15, they are—optionally—deleted in order to provide storage space for other data (cf. M4).

Such other data 18 are, in particular, data which individualize the device (cf. M5). For example, audiogram data of a user of the device and/or parameter settings data for hearing programs may then be comprised in memory 15.

Memory 15 is preferably a writable non-volatile memory, which is—like in practically all modern digital hearing-aid devices—during normal operation of the device intended for the storage of
configuration parameters that control the device's behavior, such as input-level and/or frequency dependent gain settings;
audiological data such as the user's audiograms and other information that allow a fitting of the device to be re-created independent of a specific fitting software;
customized data that define the user interface between the device and its user, e.g., individual voice messages.

It is advantageous to comprise meta-data with data 16′, which comprise for at least a part of data 16′ at least one of
a date of expiration; and
a date of creation;
   which allows to treat data 16′ or different portions thereof differently. E.g., said dates or at least one of these can be compared—upon reading data 16′ from memory 15—to at least one of
the current date;
the date of creation of other data received earlier.

Thereupon, it can be checked, preferably automatically (e.g., by a fitting software reading data 16′),
whether the information represented by the data has expired and is no longer of interest; or
whether the data have been superseded by other data received earlier;
   and, accordingly, it can be decided, whether it is still appropriate to process the data, e.g., to save the data or to display or print the information represented by the data or not.

If data 16′ comprise a multitude of files, it is advantageous to provide for such meta-data for every file and to accomplish said checking and deciding for each file.

Summarizing, a device of a hearing system—more specifically a memory 15 of such a device—is used for carrying information to a recipient. This information is typically not related to said device or to a user of said device. A device of a hearing system, which anyway has to be sent to said recipient, is used for transferring information material, which conventionally would be forwarded otherwise, e.g., sent via the internet, by mail on a separate data carrier, or directly by mail. A device of a hearing system is used for distributing data.

The recipient of the device is not necessarily identical with the recipient of the materials that are forwarded, e.g., in the case of a hearing device dispenser receiving the device and reading aural rehabilitation material out from memory 15, which aural rehabilitation material are intended for use by a customer of the hearing device dispenser.

### LIST OF REFERENCE SYMBOLS

1 hearing system
11 device, hearing device
12 device, hearing device
13 device, remote control
15 memory
16,16′ digital data representing materials
18 other data, digital data individual to a user of the hearing system; digital data to be used for operating or adjusting the device or hearing system
7 communication link
M1 . . . M5 memory in different states

1. Method for supplying a recipient with materials, comprising the steps of
a) providing at least a part of said materials in form of digital data;
b) providing a device of a hearing system, which device comprises a non-volatile memory;
c) storing said digital data in said memory;
d) forwarding said device to said recipient.

2. The method according to claim 1, further comprising the step of
e) reading said digital data from said memory.

3. The method according to claim 1, wherein said materials are hearing-related materials.

4. The method according to claim 1, wherein said materials are free from materials to be used for operating or adjusting said device of said hearing system, or said materials comprise materials in addition to materials to be used for operating or adjusting said device of said hearing system.

5. The method according to claim 1, wherein said materials comprise at least one of the group comprising
sales promotion materials, in particular materials describing best practices in the field of hearing health care and/or materials related to new products;
materials providing scientific information;
materials providing hearing-related news, in particular materials announcing upcoming events;
training materials, in particular aural rehabilitation materials;
educational materials, in particular simulation and/or demonstration materials.

6. The method according to claim 2, further comprising after step e) the step of
f) deleting said digital data from said memory, in particular wherein deleting comprises overwriting with different data.

7. The method according to claim 1, wherein said memory is adapted to comprise—during normal operation of said hearing system—data, which are individual to a user of said hearing system.

8. The method according to claim 1, wherein during step d), said memory is free from data, which are individual to a user of said hearing system.

9. The method according to claim 1, wherein said device is not adapted to individual preferences of a user.

10. The method according to claim 1, wherein said device is a hearing device.

11. The method according to claim 1, wherein said recipient is a hearing device dispenser.

12. The method according to claim 1, wherein said materials are to be used by said recipient and/or by persons related to said recipient, in particular clients of said recipient.

13. The method according to claim 2, wherein a fitting software suitable to adapting said device to the individual preferences of a user of said device is used for carrying out step e).

14. Device of a hearing system, comprising
a non-volatile memory;
digital data stored in said memory, which represent at least a part of materials to be supplied to a recipient.

15. The device according to claim 14, wherein said materials are hearing-related material.

16. The device according to claim 14, wherein said materials are free from materials to be used for operating or adjusting said device of said hearing system, or said materials comprise materials in addition to materials to be used for operating or adjusting said device of said hearing system.

17. The device according to claim 14, wherein said materials comprise at least one of the group comprising
sales promotion materials, in particular materials describing best practices in the field of hearing health care and/or materials related to new products;
materials providing scientific information;
materials providing hearing-related news, in particular materials announcing upcoming events;
training materials, in particular aural rehabilitation materials;
educational materials, in particular simulation and/or demonstration materials.

18. The device according to claim 14, wherein said memory is adapted to comprise—during normal operation of said hearing system—data, which are individual to a user of said hearing system.

19. The device according to claim 14, wherein said memory is free from data individual to a user of said hearing system.

20. The device according to claim 14, wherein said device is a hearing device.

21. Hearing system comprising a device according to claim 14.

22. Use of a device of a hearing system for supplying a recipient with materials, wherein at least a part of said materials is stored in a non-volatile memory of said device.

23. The use according to claim 22, wherein said materials are hearing-related materials.

24. The use according to claim 22, wherein said materials are free from materials to be used for operating or adjusting said hearing system.

25. The use according to claim 22, wherein said materials are free from materials individual to a user of said hearing system.
